(19) United States
(12) Patent Application Publication
(10) Pub. No.: US 2010/0107186 A1
(43) Pub. Date: Apr. 29, 2010

(54) Method of enjoying broadcasted communication services through distinct electronic apparatuses

(76) Inventors: Antonio Varriale, Torino (IT); Simonetta Mangiabene, Torino (IT); Elisa Alessio, Torino (IT); Maura Turolla, Torino (IT); Maurizio Marcelli, Roma (IT)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/311,342

(22) PCT Filed: Sep. 29, 2006
(86) PCT No.: PCT/EP2006/009470

§ 371 Date: Nov. 19, 2009

(51) Int. Cl. H04N 7/167; H04W 12/00; H04L 9/00

(52) U.S. Cl. 725/31; 455/410; 726/27

(57) ABSTRACT

A home electronic apparatus is able to receive a broadcasted communication service and to enjoy it by means of rights information; the rights information allows billing for the enjoyment. A mobile telephone terminal is associated to a subscriber card storing subscriber rights information. According to the method, at least the subscriber rights information is transferred from the mobile telephone terminal to the home electronic apparatus when the mobile telephone terminal is in proximity of the home electronic apparatus, the transferred information is stored into the home electronic apparatus, and the broadcasted communication service is received and enjoyed by means of the transferred information.

### FIELD OF THE INVENTION

The present invention relates to a method of enjoying broadcasted communication services through distinct electronic apparatuses.

### BACKGROUND OF THE INVENTION

Nowadays, communication services, such as television programs, are broadcasted through different channels. For example, the same program may be broadcasted through a dedicated cable connection, through an internet connection, through a terrestrial radio connection, through a satellite radio connection, through a mobile telephone network. The term broadcasting means in general the distribution of audio and/or video signals (programs) to a number of recipients that belong to a large group, and may comprise therefore other similar techniques, such as e.g. multicast transmission.

A user may be interested in enjoying similar broadcasted communications services through different channels, for example watching football games through his satellite receiver when he is at home and through his mobile phone when he is away from home. It is to be noted that, in general, a specific electronic apparatus is able to receive broadcasted communication services through only one channel. In this case, the user needs in general various different subscriptions (even with the same service provider) in order to be able to enjoy and pay the same or similar services.

This is cumbersome both as it requires a number of subscriptions and as it requires a number of bills to be issued and paid.

It is to be noted that, in general, a specific electronic apparatus is able to receive broadcasted communications services through only one channel.

Additionally a mobile user may be interested in enjoying the same broadcasted communications service through distinct (typically similar) electronic apparatuses, for example, watching football games through his satellite receiver when he is at home and through a hotel's satellite receiver when he is on travel. In this case, even having different subscriptions may not be sufficient.

From patent application US20050130585, there is a known a subscriber identity system (SIS) that includes a subscriber mobile identity component (SMIC) and a video security component (VSC) such that both the cellular and video services can be authenticated. The subscriber identity system (SIS) in the form of a card is fit within a personal base station (PBS) that acts as a base station but within a personal environment and transmits content, e.g. video, to a mobile device. Alternatively, the subscriber identity system (SIS) in the form of a card is fit directly within a mobile device for both services.

### SUMMARY OF THE INVENTION

The Applicant remarks that, in the solution according to US20050130585, the subscriber identity system (SIS) card integrates two cards permanently storing full identification and authentication information for both services.

As already clarified, the Applicant has noticed that a user has the need of enjoying the same or similar broadcasted communications services, typically TV programs, through distinct electronic apparatuses.

Additionally, the Applicant has noticed that a user has also the need to have these services customized in the same or similar way.

Billing of these services should be safe and reliable; this is especially important when the electronic apparatuses are used by different users and even more when they are in a public place, e.g. a hotel or a airplane.

It is the object of the present invention to meet at least part of these needs.

The Applicant has considered having a smart card adapted to transfer subscriber rights information stored therein to electronic apparatuses so that they can use it for receiving and enjoying broadcasted communication services autonomously with respect to the smart card. In this way, thanks to a single smart card (i.e. a single subscription and a single billing and payment process) the same or similar broadcasted communication services can be enjoyed through distinct electronic apparatuses.

By subscriber rights information it is meant any information that enable an electronic apparatus for broadcast reception to establish whether enjoyment of a received communication service, e.g. a television program, is allowed or not or, in other terms, whether a user has the right to enjoy this service because it is free or because he has already paid for it or because he is paying for it (having just provided e.g. his credit card number to the service provider) or because he is bound by contract to pay for it. For example, it can be at least one specific service identity (appropriately coded), at least one decryption key associated to a specific service, a credit information associated or not to specific services, a time validity associated or not to specific services, a subscriber or subscription identity (appropriately coded), or combination thereof.

Typically this smartcard, called “Master card” or subscriber card, is fit within a mobile telephone terminal, e.g. a cellular phone.

Advantageously, the subscriber rights information is transferred to another smart card, called “Slave card” or apparatus card, that is typically fit within a home electronic apparatus, e.g. a set-top-box television receiver.

In the following description the term “home electronic apparatus” refers in general to an electronic apparatus able to receive a broadcasted communication service, in particular the home use of the apparatus is given by way of example and not of limitation.

The present invention advantageously provides to transfer, in particular from the Master card to the Slave card, not only subscriber rights information but also subscriber preferences information and/or applications and/or application commands.

Communication between the two smart cards can be direct, reliable and secure by means of a secure wireless technology such as ZigBee™. In this way, security for the subscriber rights information is improved because the source of transmission is secure, as it may be a secure module implemented through a smart card, the destination of transmission is secure, as it may be a secure module implemented through a smart card, and the communication (or transmission) channel is secure. The term smart cart identifies herein in general a card having i.a. processing functionalities and, preferably, tamper-resistant properties, e.g. a secure crypto-processor and a secure file system.

### BRIEF DESCRIPTION OF THE DRAWINGS

The present invention will become more apparent from the following description to be considered in conjunction with the annexed drawings, wherein:

FIG. 1 shows schematically a system according to the present invention,

FIG. 2 shows a schematic block diagram of part of the system of FIG. 1,

FIG. 3 shows a possible split of the software in smartcards according to the present invention, and

FIG. 4 shows a possible software architecture for secure applications in smartcards according to the present invention.

It is to be understood that the following description and the annexed drawings are not to be interpreted as limitations of the present invention but simply as exemplifications.

### DETAILED DESCRIPTION OF THE INVENTION

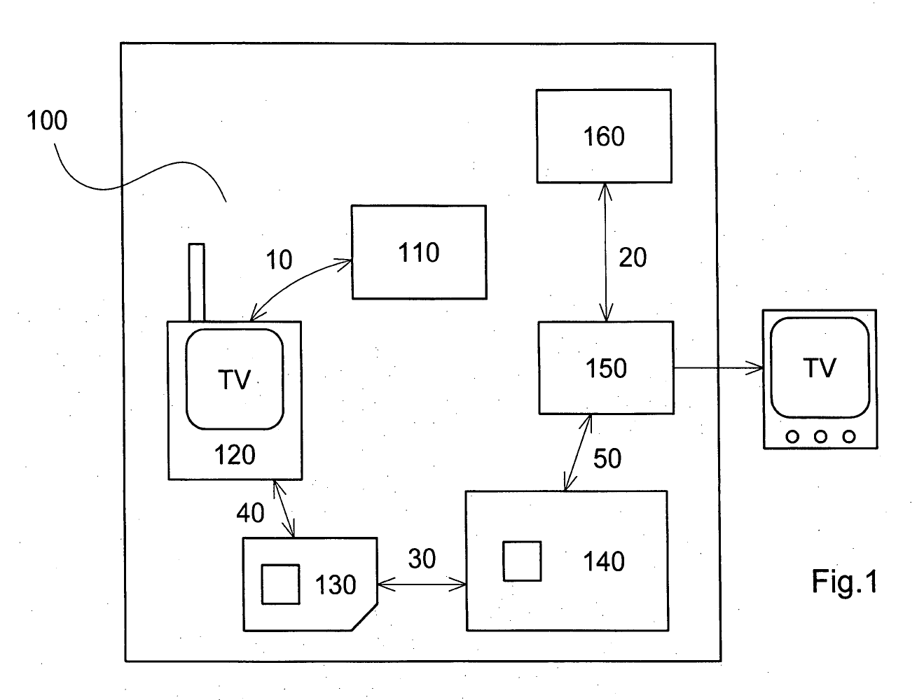

In FIG. 1, the whole system is indicated with reference 100. System 100 comprises:
a telecommunication network 110, for example Telecom Italia 2G/3G network;
a mobile telephone terminal 120, for example a DVB-H [Digital Video Broadcasting-Handheld] technology mobile phone for exchanging phone calls and also for receiving TV programs;
a first smartcard 130, specifically a “Master” card, having an integrated radio communication unit;
a home electronic apparatus 150, for example a set-top-box television receiver able to receive communication services broadcasted through any suitable technology (an ordinary TV set is shown in FIG. 1 connected to set-top-box TV receiver 150 clearly not in scale with respect to the DVH-B mobile phone);
a second smartcard 140, specifically a “Slave” card, having a integrated radio communication unit; and
a TV broadcasting playout 160.

In order to simplify the description of the present invention, the scenario shown in FIG. 1 is reduced to its minimum, i.e. one mobile telephone terminal and one home electronic apparatus. Anyway, in general there may be many home electronic apparatuses; in fact, as already explained before, a mobile user has the need of using the same or similar broadcasted communication services through distinct home electronic apparatuses. In a general case, there may be a plurality of home electronic apparatuses and a plurality of mobile telephone terminals.

Smartcards 130 and 140 may have the architecture and the internal operation disclosed e.g. in patent applications WO2005104584 and WO2006056220 of the same Applicant; in particular, specific functionalities (implemented e.g. in additional firmware) are provided for in the Master card 130 and in the Slave card 140.

In the embodiment of FIG. 1, smartcard 130 has all the functionalities of a SIM [Subscriber Identification Module] card and additional functionalities that will be described in the following; while smartcard 140 has functionalities of a common television smartcard, e.g. a subscriber rights database, subscriber rights verification and generation of video streaming keys, and additional functionalities that will be described in the following.

The radio communication units of smartcards 130 and 140 are of the (relatively) short range type; in other words, are adapted for the so-called WPAN [Wireless Personal Area Network] applications; for example they use the ZigBee™ standard technology. This technology is particularly suitable for the present invention due to the kind of information transmitted and received by the smartcards, i.e. secret. Alternatively, these radio communication units may use the Bluetooth™ standard technology. These technologies provide for radio proximity detectors associated to a radio coverage space that can be programmable.

Smartcard 130, like any SIM card, stores subscriber identification information; for GSM, the identification information consists of an IMSI [International Mobile Subscriber Identity] code, strictly for identification, and a KI [Individual Subscriber Authentication Key] key, for identity authentication.

In general, smartcard 130 stores subscriber rights information for enabling enjoyment of one or more broadcasted communication services; for example, subscriber identification information may be used as subscriber rights information for identifying the subscriber that is interested in enjoying the service and that has to be billed.

Subscriber rights information may be stored into SIM card 130 for example directly by the service provider or by a dealer of the service provider; it can be stored for example through the mobile telecommunication network, i.e. through a wireless connection, or in a shop by a specific apparatus, i.e. through a wired connection.

As already said, subscriber rights information can be at least one specific service identity (appropriately coded), at least one decryption key associated to a specific service, a credit information associated or not to specific services, a time validity associated or not to specific services, a subscriber or subscription identity (appropriately coded), or combinations thereof.

Smartcard 140, like any TV smartcard, enables the enjoyment, including decryption if necessary, of broadcasted TV programs.

According to the present invention, “Master” and “Slave” capabilities are defined:
Master: smartcard associated to the subscriber, to be inserted into the mobile telephone terminal; and
Slave: smartcard associated to the apparatus, to be inserted into the home electronic apparatus, configurable and programmable by a Master card.

In the embodiment of FIG. 1, such configuring and programming is carried out through a proximity radio communication channel 30 implemented thanks to the radio communication units of the two smartcards.

In the embodiment of FIG. 1, the Slave card 140 can be configured by the Master card 130 in terms of subscriber rights and subscriber preferences. The Slave card 140 can be programmed by the Master card 130 in terms of applications to be run typically in the associated home electronic apparatus. The Master card 140 can also query the Slave card 130 about the functionalities that the apparatus associated thereto is able to export; in this case, for example, the mobile telephone terminal 120, through the Master card 130, could be able to remotely control and/or execute, through the Slave card 140, applications resident in the home electronic apparatus 150.

The system 100 of FIG. 1 includes three kinds of radio communication channels. The first one is a proximity (or short range) radio channel 30, which is the radio channel among the cards 130 and 140. The second one is a wide range radio channel between the network 110 and the mobile telephone terminal 120 and is indicated with reference 10. The third one is a broadcasting channel (typically implemented through any broadcast TV network) between the playout 160 and the home electronic apparatus 150 and is indicated with reference 20. It is to be noted that while the channel between the network and the mobile telephone terminal has to be radio type, the communication channel associated between the playout and the home electronic apparatus may be of the wired type (based e.g. on electric cable or optical fibre) or wireless (i.e. radio, e.g. terrestrial radio or satellite radio) type or even mixed type Additional, it must be remembered that services, like TV programs, may be broadcasted also through the Internet.

Master card 130 and Slave card 140 are respectively connected to mobile telephone terminal 120 and home electronic apparatus 150 through a communication interface, for example both through the known ISO7816 standard interface. For clarity purposes, the two communication interfaces are indicated with two different references, respectively 40 and 50; in fact, in general, they may be different and/or according to proprietary specifications; this applies especially for interface 50 between Slave card 140 and apparatus 150.

According to the above description, system 100 provides for two smartcards 130 and 140 each implementing a secure module.

Alternatively, one or both of them can be realized through a SDIO [Secure Digital Input/Output] card or a USB [Universal Serial Bus] dongle and a corresponding interface in the apparatus; this solution is particularly applicable to the home electronic apparatus. According to a preferred implementation of this alternative, this SDIO card/USB dongle has an integrated proximity radio communication unit preferably with the features described above, i.e. using ZigBee™ or BlueTooth™ technology.

Anyway, it is indeed possible that the secure module and/or the associated proximity radio communication unit is integrated in the apparatus; this solution is particularly applicable to the home electronic apparatus. Even in this case, the two preferred communications technologies are ZigBee™ or BlueTooth™.

Whatever the implementation of the secure module(s), the corresponding hardware architecture and software architecture may be quite similar or even identical.

The components of system 100 appropriately interact between each other and in this way a user can enjoy communication services broadcasted by means of both network 110 and playout 160; the service is finally provided to the user by the mobile telephone terminal 120 and by the home electronic apparatus 150 thanks to the subscriber rights information stored in the Master card 130 that may be also transferred to the home electronic apparatus 150, particularly to the Slave card 140.

The mobile telephone terminal 120 and the home electronic apparatus 150 provide services to the user according to their own capabilities and by means of the same subscriber rights information; in the first case stored locally in a permanent way and in the second case received from the outside and stored locally typically in a volatile way. For these purposes, the home electronic apparatus 150 may need different kinds of subscriber rights information; all such information is typically stored in a subscriber card, like e.g. a SIM card, and in the embodiment of FIG. 1 it is stored in the Master card 130 and transferred to the Slave card 140 through the proximity radio communication channel 30. Regarding the mobile telephone terminal 120, typically, it has already available locally this information in the user's profile stored in the SIM card and is designed to use it during its operation.

The home electronic apparatus 150 may be able to customize the services provided to the user; for this purpose, it needs subscriber preferences information; subscriber preferences information is typically stored in a subscriber card, like e.g. a SIM card, and in the embodiment of FIG. 1 it is stored in the Master card 130 and transferred to the Slave card 140 through the proximity radio communication channel 30. Regarding the mobile telephone terminal 120, typically, it has already available locally this additional information in the user's profile stored in the SIM card and is designed to use it during its operation.

It is to be understood that the transfer of the subscriber information takes place when the mobile telephone terminal is in proximity of the home electronic apparatus, more specifically when it enters its coverage its radio coverage space. The transferred subscriber information is stored into the home electronic apparatus, particularly into the associated Slave card 140, in order to be used thereafter one or more times by the home electronic apparatus for using and/or providing services independently from the Master card 130. Such storage may be temporary or permanent; in the temporary case, storage may start when the mobile telephone terminal comes in proximity of the home electronic apparatus, more specifically when it enters its coverage space, and may end when the mobile telephone terminal gets out of proximity of the home electronic apparatus, more specifically when it exits its coverage space; the end of storage may correspond either to the removal (i.e. deletion or erasure) of the transferred information from storage means or to its disabling (e.g. marking the stored information as not accessible or not usable).

It is to be noted that in the embodiment of FIG. 1 the transfer of information takes place directly between the two smartcards; anyway, in alternative embodiments the transfer of information between the two smartcards may take place through the mobile telephone terminal and the home electronic apparatus, e.g. through a direct communication between the mobile telephone terminal and the home electronic apparatus.

An example will be provided in the following in order to explain the configuration procedure.

Let us consider, for example, a set-top-box TV receiver connected to a satellite antenna and to a TV set. In order to send certain received TV programs (i.e. the non-free ones) to the TV set for displaying them on its screen, the set-top-box needs information about a subscriber (identity, decryption key, . . . ); this is very often done by inserting a TV smartcard into the set-top-box.

According to the prior art, in order to manage a single subscription, a mobile user has to carry his TV smartcard with him and to insert it into the set-top-box TV receiver where he is located before a specific program of interest and extract it after this program; this may work well if the all the set-top-box TV receivers are identical or at least compatible from the smartcard point of view. Anyway, if this user would have a need to watch this specific TV program on his mobile phone, he would require a different subscription.

The present invention allows to project temporarily the subscriber information, in particular subscriber rights information, of the Master card 130, which remains inside the mobile phone, on the Slave card 140, fit inside the set-top-box TV receiver, so that the TV receiver is able to provide the TV program to the user, without removing any card; this projection is carried out through the proximity radio communication channel 30. Typically, such projection starts when the mobile phone 120 and the associated Master card 130 enters into the radio coverage space of the Slave card 140, continues during the coverage time, and ends when the mobile phone 120 and the associated Master card 130 exits the radio coverage space of the Slave card 140.

As the communication between the two secure modules is through a secure channel (implemented through ZigBee™ wireless technology), security for the subscriber rights information is fully guaranteed, i.e. no abuse are possible. In particular the security of the channel is guaranteed by encryption of the data packets on the radio link at physical level. Such encryption may be obtained e.g. by means of symmetrical keys previously distributed to the secure modules, or by means of session keys dynamically generated from digital certificates.

As no card is extracted from any apparatus, in principle both apparatuses could be used at the same time; this makes sense as a need exists that a user watch a TV program on his mobile phone being on a train while his son watches the same TV program on a TV set being at home. Anyway, this is a matter of service policy on one side and technical constraints on the other side; in fact, in the example of FIG. 1, the broadcast service provider should be able to deal at the same time with two distinct apparatuses associated to the same subscriber. A simpler solution would be that a Master card that has projected its subscriber rights information on a Slave card is no longer able to use its subscriber rights information till when projection is terminated.

In the described example, the Slave card is a temporary projection of the Master card; in other words, the Master card configures the Slave card.

Such projection/configuration may apply to all the functions carried out by the Slave card or only to some of them; in the latter case, the Slave card carries out some functions irrespective of the proximity to a Master card. An example of this feature may be the following; a person visits a friend and carries his mobile phone having a SIM card according to the present invention and storing the person's subscription information; the friend has a set-top-box TV receiver having a smartcard according to the present invention and storing the friend's subscription information; when the mobile phone is in proximity of the TV receiver the Master card of the mobile phone configure the Slayer card of the TV receiver (provided e.g. that the person agrees to such programming); from that time on any TV set connected to the set-top-box TV receiver will be able to show all the programs allowed by both subscriptions; as soon as the mobile phone is out of proximity, to the set-top-box TV receiver will be able to show only the programs allowed by the friend's subscription.

It may be appropriate to provide that a Master card does not project all configuration information (subscriber rights and preferences information) but only those which are likely to be useful or necessary for a home electronic apparatus associated to a Slave card.

The method according to the present invention may be used to permanently transfer rights information (connected to broadcasted communication services) from the mobile telephone terminal of a first person to the home electronic apparatus of a second person. This may be useful for selling rights; in this case, the first person is the owner of a shop and the second person is a client of the shop. This may also be useful for making presents; in this case, the second person is a friend of the first person. In both cases, the right or rights stored in the smart card associated to the mobile telephone terminal are removed or disabled after having been transferred to the smart card associated to the home electronic apparatus.

The present invention advantageously provides that the Master card not only configures but also programs the Slave card; this is used to add (i.e. store) further applications (and therefore functionalities) either to the Slave card or to the home electronic apparatus associated thereto.

The present invention advantageously provides that the coupling of Master card and Slave card allows the mobile telephone terminal to remotely control and/or use the functionalities of the home electronic apparatus. A typical application of this feature is to use the mobile phone as a remote control device of the set-top-box TV receiver.

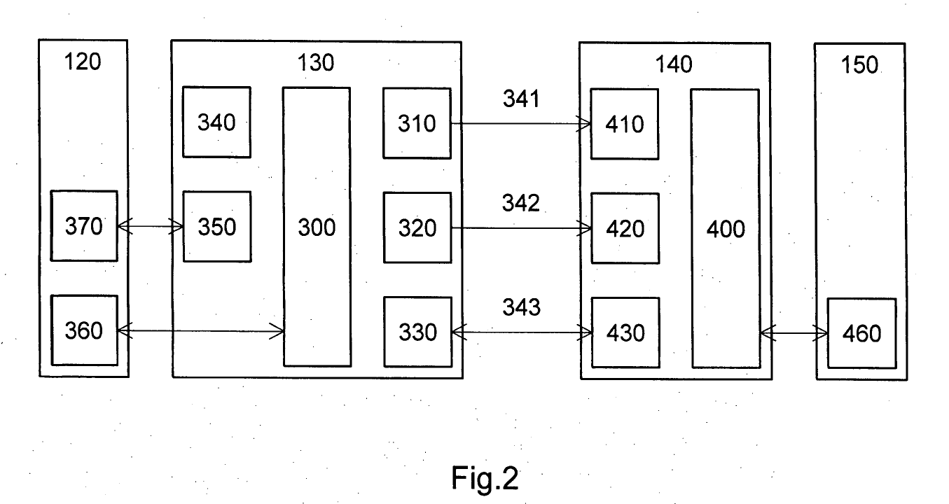

As shown in the embodiment of FIG. 2, the Master card 130 is able to configure (arrow 341), program (arrow 342) and send commands (arrow 343) to the Slave card 140.

The Master card middleware stack is made up of an Application Manager 300 which manages local (to the card) applications 340 and external (to the card) applications 360 and 370 that are typically on the mobile telephone terminal 120; applications 360 interact directly with the Application Manager 300 while applications 370 interact indirectly with the Application Manager 300 through an internal (to the card) application layer 350.

Application requests in the mobile telephone terminal 120 can be translated in different processes which are managed by three specific blocks 310, 320, 330 in the Master card 130. The first block is the Configuration Sender Block 310, which is adapted to transfer subscriber information (e.g. identification and/or rights and/or credit and/or preferences) from the Master card to the Slave card. The second block is a Program Sender Block 320, which is adapted to transfer applications from the Master card to the Slave card. The third block is a Command Sender Block 330, which is adapted to send commands, typically applications commands, from to the Master card to the Slave card; the third block may be also adapted to receive replies to these commands and this is why arrow 343 is bidirectional.

Arrows 341, 342, 343 represent data flows between the mobile telephone 120 and the home electronic apparatus 150, more particularly between the Master card 130 and the Slave card 140. These date flows are implemented through the proximity radio communication channel 30 advantageously based on ZigBee™ technology.

In the home electronic apparatus 150, specifically in the associated Slave card 140, there are three blocks corresponding to the above mentioned blocks in the Master card 130, namely a Configuration Receiver Block 410, a Program Receiver Block 420 and a Command Receiver Block 430. In the Slave card 140 there is also an Application Manager 400 which manages applications; in home electronic apparatus 150 associated to card 140, one or more applications 460 is/are adapted to interact with the Application Manager 400.

Applications 460 in the home electronic apparatus 150 may be added and/or upgraded through the programming procedure that is implemented in the embodiment of FIG. 2 essentially through blocks 320 and 420. This may apply also to applications stored in the Slave card 140.

The programming procedure may imply a permanent or temporary transfer/storage of an application. The first case is useful e.g. for upgrading applications (in the Slave card and/or in the home electronic apparatus) and the second case is useful for temporary increasing number and/or functionalities of the applications to be run in the home electronic apparatus in relation to the proximity of a Master card. It is to be noted that the information necessary for the upgrading may be received by the Master card from the outside, for example the telecommunication network 110.

The commanding procedure may be used, in principle, by any application, either in the Master card 130 (i.e. applications 340) or in the mobile telephone terminal 120 (i.e. applications 360 and 370). This functionality is useful when an application in the mobile telephone terminal 120, in particular in the associated Master card 130, has the need to communicate/interact with an application in the home electronic apparatus 150, in particular in the associated Slave card 140; this is typically the case of remote control of an application.

As already said, the communication channel between block 330 and block 430 is bidirectional because each command may be followed by a reply, e.g. confirmation that the command has been received or executed correctly.

Specific commands may be provided which allow downloading new applications (e.g. applications 340 and/or 350 and/or 360 and/or 370) from the Slave card 140 to the Master card 130; in this case, the data flow from the Slave card 140 to the Master card 130 does not consist of simple replies. In general, applications may be transferred (and thereafter stored) from the office electronic apparatus, and/or from the associated Slave card, to the telephone terminal and/or to the associated Master card, passing through one or more smartcards.

The communications between the Master card 130 and the Slave card 140, i.e. communication channel 30, may be of the encrypted type. In case the ZigBee™ technology is used, the encryption is at physical level; in general, there is always the possibility of implementing a secure channel between the two cards at application level using known technologies.

It is worth noting that the term “Master” does not necessarily refer to the entity which starts communication with the “Slave”; a Slave card may start with a message requesting information to the Master card and the Master card may reply by transferring the requested information. For example, an application running in a home electronic apparatus associated to a Slave card may issue a request of credentials/keys; if the Slave card has already received these credentials/keys from a Master card, the application will use them for login, otherwise the application will send a request message to any mobile telephone terminal (associated to a Master card) located in its proximity by means of the Slave card and will wait for a reply.

An implementation of the dialog between Master card 130 and Slave card 140 in case of remote control of an application can be, e.g. the following:

1) Master card 130 sends a “join” command to Slave card 140 using block 330 in order to build up the communication channel;
2) Slave card 140 sends a “joint successful” reply to acknowledge receipt of the command using block 430;
3) Master card 130 sends a “Remote Control Application Request” command to check for a specific application on Slave card 140 using block 330;
4) Slave card 140 sends an “Application Available” reply to acknowledge receipt of the command using block 430;
5) Master card 130 sends remote commands to Slave card 140 (specifically to the application to be controlled) using block 330;
6) Slave card 140 sends acknowledgment replies for each executed command using block 430;
7) at the end of the application, Master card 130 sends a “detach” command to Slave card 140 using block 330 in order to release the application; and
8) Slave card 140 sends a “detach successful” reply to acknowledge receipt of the command using block 430.

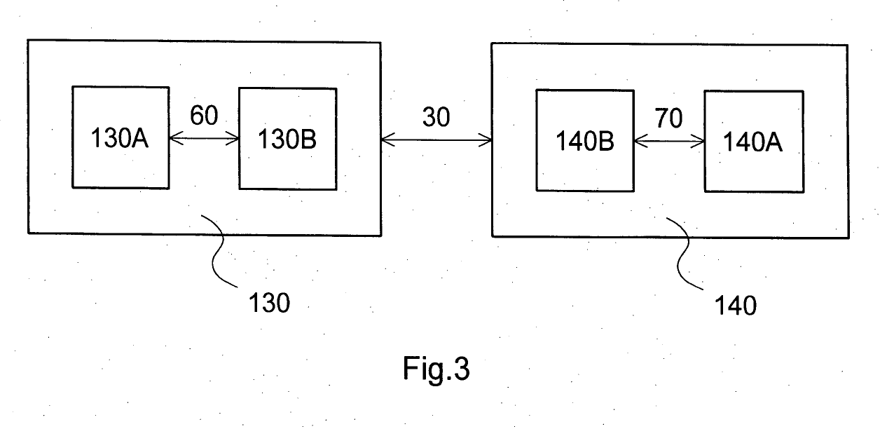

As shown in FIG. 3, from the software point of view, the Master card 130 and the Slave card 140 can be split in two parts. The first one is the proximity radio software layer 130B and 1408 and the second one is the application software layer 130A and 140A. The two layers are connected by an internal communication channel 60 and 70, which can be physical or logical according to the implementation of the cards. Advantageously, the present invention allows separating the application layer from the radio layer, so that the software development can be independent.

The separation can be obtained by defining a common interface between the application layer and the radio layer as follows:
“Activate”: activate the radio layer communication
“Send”: send a command/reply to another card, through the proximity radio channel
“Receive”: receive a reply/command from another card, through the proximity channel
“Control”: send a control/configuration command to the radio layer
“Deactivate”: deactivate the radio layer

The above functions allow building the firmware architecture described before and transport specific commands.

From the radio layer point of view, there are two kinds of commands coming from the application layer: “to be passed” (PAS) and “to be parsed” (PAR).

Referring to FIG. 3, the PAS commands are straightly transmitted to another card by the radio layer 130B without being parsed; the PAR commands are parsed and executed at the radio layer 130B.

PAR and PAS concepts can also be applied to functions, i.e. a group of commands. Only the following combinations are permitted:

PAS Function transporting PAR Commands;
PAS Function transporting PAS Commands;
PAR Function transporting PAR Commands;
PAR functions are not allowed to transport PAS commands.

The “Activate” is a PAR function and transports a PAR command for the radio layer 130B. The command is actually parsed and executed at the radio layer 130B, which gets ready to perform the radio operations.

The “Send” is a PAS function. It is able to transport both PAR and PAS commands. In the first case (PAR), the transported command is sent from the application layer 130A to the radio layer 140B. Then the command is parsed and executed at the radio layer. This is useful for remote configuration of the radio layer, for example to set the radio power of the Slave card 140 from the application layer of the Master. card 130. In the second case (PAS), the transported command is sent from the application layer 130A to the application layer 140A. The command is parsed and executed from the application layer, for example to show the next picture of the laptop presentation.

The “Receive” is a PAS function and transports a PAS command. This is a callback function generated, for example, at the application layer of the Slave card 140 after a Master card “Send” function with PAS command.

It is to be remarked that “Send” and “Receive” functions can be activated with distance limitation. For example, the ZigBee™ standard allows defining the range of the proximity transmission so that it is possible to create/enable proximity services according to the distance between the Master card and the Slave card. This capability is useful for avoiding interferences between apparatuses (receivers and/or phones) located e.g. in adjacent apartments.

The “Control” is a PAR function and transports PAR commands. This is used from the application layer 130A to set or get radio parameters related to the radio layer 130B.

The “Deactivate” is a PAR function and transports a PAR command for the radio layer 130B. The command is actually parsed and executed at the radio layer 130B, which gets switched off.

“Activate” and “Deactivate” functions are useful in order to minimize power consumption. In case of ZigBee™ technology, for example, these functions are used in synchronized way so that the Slave card is able to receive commands from the Master card just when commands are sent. The Master card and the Slave card activate the radio part just in particular time slot, as configured at the beginning when the communication channel is initialized.

The above functions above can be used to implement all the scenarios previously described. In the remote control of applications, for example, the following operations could be implemented:
“Activate”: perform the join operation,
“Control”: check for remote control application availability,
“Send”: send remote commands (e.g. “Next_Channel”, “Previous_Channel”, “Volume_Up”, “Volume_Down”, etc.),
“Deactivate”: detach the remote control application.

It is to be noted that, in order to simplify the description of the common interface, the above functions have been described considering the Master card, i.e. the smartcard associated to the mobile telephone terminal and to the subscriber, as the communication starter; but this should not be interpreted as a limitation of the present invention.

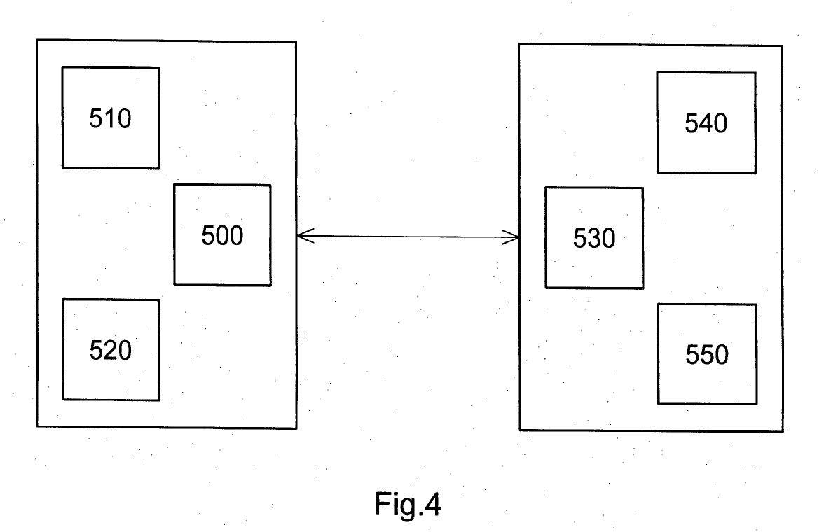

One important feature of the present invention is the management of rights of a subscriber to enjoy broadcasted contents. To this regard, the software architecture for secure applications in Master card 130, i.e. a SIM card with an integrated radio communication unit, and in Slave card 140, i.e. a TV smartcard with an integrated radio communication unit, is shown in FIG. 4.

In order to protect broadcast contents and manage the subscriber rights, a Content Access System or CAS is usually implemented in a broadcasting delivery system based on SIM (for mobile telephone terminals like mobile phones) or on TV smartcard (for home electronic apparatuses like set-top-box TV receivers). The CAS is basically made up of a secure application executed inside the smartcards and a complementary application executed inside the terminal or apparatus that communicates with the secure application to retrieve the video broadcasting keys that allow decrypting the audio/video stream.

By means of the teaching described in the present invention a Master card, e.g. 130, and a Slave card, e.g. 140, can be used to protect the broadcast contents and manage the subscriber rights. As shown in FIG. 4 the Secure Application inside the Master card and the Slave card can be split in three parts:
Secure Application Cores 500 (for Master) and 530 (for Slave);
Rights Data Bases 510 (for Master) and 540 (for Slave);
Rights Transfer Module 520 (for Master) and 550 (for Slave).

It is to be noted that the use of a secure application core and a right data base in a TV smartcard is known and common for this kind of applications. What is totally new is the idea of transferring rights and therefore the presence of blocks 520 and 550 respectively in smartcard 130 and 140.

When the CAS are the same both for the mobile telephone terminal and the home electronic apparatus, the rights transfer can be easily performed directly by using the proximity radio communication channel (30 in the figures).

In particular, two cases may be considered.

In a first case, the owner of the mobile telephone terminal wants to transfer some rights to the home electronic apparatus. From a graphic user interface [GUI] on the terminal the user recognizes an apparatus in proximity and decides to send some rights selected by him (e.g. through the same GUI), for example the right to watch a movie. The Rights Transfer Unit 520 search for the selected right on the Mobile Terminal Rights Data Base 510 and transfers them to the complementary block 550 through the proximity channel 30. The block 550 stores the new right in the apparatus Rights Database 540 so that the owner of the apparatus can access the movie through the broadcast channel associated to the apparatus. In this case, we talk about a push rights transfer.

In a second case, the owner of the home electronic apparatus try to watch some un-subscribed event. The apparatus try to send a rights request to a Master card in proximity (when present). If the Master card is able to give the requested right, after a user confirmation on the mobile telephonic terminal, the block 510 sends it to the block 550 as in the previous case. In this case, we talk about a pull rights transfer.

When the CAS in the Master card is different from the CAS in the Slave card it may be difficult to manage the rights transfer locally (i.e. through the proximity radio communication channel) because protocols, database rights and structures do not match and are probably proprietary of the CAS Vendor.

In this case, the blocks 520 and 550 can be just used to select the rights to be transferred. The real transfer may happen through the network 110. In particular, after selecting the rights to be transferred, the Master card through the mobile telephone terminal communicates to the network 110 that the owner of the Master card is giving some rights to the owner of the Slave card. The network 110 updates the rights in a remote rights data base (which is an ordinary feature of architectures for managing rights of broadcast contents) and communicates to the playout 160 that some rights on the Slave card have to be updated through the broadcast channel 20 of the apparatus 150 by means of a rights update procedure (which is an ordinary feature of broadcast contents purchasing). The owner of the Master card can correspond to the Slave card. The use of the Master card and Slave card couple allows upgrading/transferring rights without using external procedures like e.g. phone calls to call centre request for purchasing or updating rights.

In general, the present invention allows to easily manage a user subscription, its billing and the updating/purchasing of rights.

According to the present invention, the return channel from the television receiver (e.g. set-top-box television receiver 150) to the broadcasted service provider may advantageously be implemented by means of and through the smart cards. In fact, the smart card (e.g. 140) associated to the television receiver (e.g. 150) may send commands to the smart card (e.g. 130) associated to the mobile telephone terminal (e.g. 120) and the mobile telephone terminal (e.g. 120) may send information to the broadcasted service provider through the mobile telecommunication network (e.g. network 110). Such a return channel is practical to be implemented as it does not require any further connection of the television receiver.

Although the present invention is centred on a method teaching, one important aspect regards smartcards, specifically a Master card or subscriber card and a Slave card or apparatus card. In the following their main technical features will be described.

In general, according to the present invention, the Master card (e.g. 130) is a smart card adapted to be associated to a local electronic apparatus (e.g. 120), in particular a mobile telephone terminal; it stores at least subscriber rights information and comprises a configuration block (e.g. 310) adapted to transmit the stored subscriber rights information to a remote electronic apparatus for broadcast reception (e.g. 150), in particular to a smart card (e.g. 140) associated to the remote electronic apparatus; the transmitted information is adapted and sufficient to be used by the remote electronic apparatus for autonomously enjoying broadcasted communication services.

The configuration block (e.g. 310) may be adapted to transmit not only subscriber rights information but also subscriber preferences information to the remote electronic apparatus, in particular to the smart card associated to the remote electronic apparatus.

The Master card (e.g. 130) may comprises also a programming block (e.g. 320) adapted to transmit applications to the remote electronic apparatus, in particular to the smart card associated to the remote electronic apparatus.

The Master card (e.g. 130) may comprise also a controlling block (e.g. 330) adapted to transmit application commands to the remote electronic apparatus, in particular to the smart card associated to the remote electronic apparatus.

The Master card (e.g. 130) may comprise also a radio communication unit for communicating with remote electronic apparatuses, in particular with the smart cards associated to remote electronic apparatuses, in particular through ZigBee™ technology.

The Master card (e.g. 130) may comprise also a radio proximity detector associated to a radio coverage space and adapted to detect a remote electronic apparatus, in particular a smart card associated to a remote electronic apparatus, when inside this radio coverage space.

The Master card according to the present invention may comprise other features; for example and typically, like card 130, it comprises at least the essential features of a telephone SIM or USIM, such as operator network authentication functionalities.

In general, according to the present invention, the Slave card (e.g. 140) is a smart card adapted to be associated to a local home electronic apparatus for broadcast reception (e.g. 150); it comprises a configuration block (e.g. 410) adapted to receive and store a subscriber rights information from the remote electronic apparatus (e.g. 120), in particular from the smart card (e.g. 130) associated to the remote electronic apparatus, and is adapted to use the received information for autonomously enjoying broadcasted communication services.

The configuration block (e.g. 410) may be adapted to receive also subscriber preferences information from the remote electronic apparatus, in particular from the smart card associated to the remote electronic apparatus.

The Slave card (e.g. 140) may comprise also a programming block (e.g. 420) adapted to receive applications from the remote electronic apparatus, in particular from the smart card associated to the remote electronic apparatus.

The Slave card (e.g. 140) may comprise also a controlling block (e.g. 430) adapted to receive application commands from the remote electronic apparatus, in particular from the smart card associated to the remote electronic apparatus.

The Slave card (e.g. 140) may be further adapted to transfer to the received applications and/or said received commands to the associated local electronic apparatus (e.g. 150).

The Slave card (e.g. 140) may comprise also a radio communication unit for communicating with remote electronic apparatuses, in particular with a smart cards associated to remote electronic apparatuses, in particular through ZigBee™ technology.

The Slave card (e.g. 140) may comprise a radio proximity detector associated to a radio coverage space and adapted to detect a remote electronic apparatus, in particular a smart card associated to said remote electronic apparatus, when inside this radio coverage space.

The Slave card according to the present invention may comprise other features; for example, like card 140, it comprises some features of a television smart card, e.g. a subscriber rights database, subscriber rights verification and generation of video streaming keys.

It is to be understood that, once the subscriber rights information is transferred from the Master card to the Slave card, the Slave card has the minimum information necessary for allowing the associated electronic apparatus to autonomously enjoy broadcasted communication services in the ordinary way, without the further help of the Master card.

1-39. (canceled)

40. A method of enjoying broadcasted communication services comprising the steps of:
A) providing an electronic apparatus able to receive a broadcasted communication service and to enjoy it by means of subscriber rights information;
B) providing a mobile telephone terminal;
C) associating a subscriber card storing subscriber rights information to said mobile telephone terminal;
D) transferring at least said subscriber rights information from said mobile telephone terminal to said electronic apparatus when said mobile telephone terminal is in proximity of said electronic apparatus;
E) storing said transferred information in said electronic apparatus; and
F) receiving and enjoying said broadcasted communication service by means of said transferred information.

41. The method according to claim 40, further comprising the step of:
G) associating an apparatus card with said electronic apparatus.

42. The method according to claim 41, wherein said transferred information is stored in said apparatus card.

43. The method according to claim 41, wherein the transferring of step D takes place directly between said subscriber card and said apparatus card.

44. The method according to claim 40, further comprising the step of:
H) providing said electronic apparatus with a radio proximity detector associated with a radio coverage space and adapted to detect a mobile telephone terminal when inside said radio coverage space.

45. The method according to claim 40, wherein step D provides for wireless transfer.

46. The method according to claim 41, wherein said subscriber card and said apparatus card each comprise a radio communication unit for communicating together.

47. The method according to claim 46, wherein said radio communication units operate through ZigBee™ technology.

48. The method according to claim 40, further comprising the step of:
I) removing or disabling said transferred information when said mobile telephone terminal is out of proximity of said electronic apparatus.

49. The method according to claim 40, wherein said subscriber rights information comprises one or more decryption keys.

50. The method according to claim 40, wherein said subscriber rights information comprises subscriber identity and/or subscriber credit and/or subscriber validity.

51. The method according to claim 40, wherein step D also provides for transferring subscriber preferences information.

52. The method according to claim 40, wherein step D also provides for transferring applications.

53. The method according to claim 40, wherein step D provides for transferring application commands to applications running in said electronic apparatus.

54. The method according to claim 40, wherein said broadcasted communication services are broadcasted television programs.

55. The method according to claim 40, wherein both said electronic apparatus and said mobile telephone terminal enjoy the same broadcasted communication service at the same time.

56. The method according to claim 40, further comprising the step of:
L) establishing a return channel from the electronic apparatus to the broadcasted service provider,
wherein the return channel path comprises at least the subscriber card associated with the mobile telephone terminal, the mobile telephone terminal and a mobile telephone network.

57. A smart card capable of being adapted to be associated with a local electronic apparatus, storing subscriber rights information, and comprising a configuration block capable of being adapted to transmit said stored subscriber rights information to a remote electronic apparatus for broadcast reception, said transmitted information being adapted and sufficient to be used by said remote electronic apparatus for enjoying broadcasted communication services autonomously with respect to the smart card associated with said local electronic apparatus.

58. The smart card according to claim 57, wherein said configuration block is capable of being adapted to transmit said stored subscriber rights information to a smart card associated with said remote electronic apparatus.

59. The smart card according to claim 57, comprising a radio communication unit for wireless communication.

60. The smart card according to claim 57, comprising at least operator network authentication functionalities of a telephone subscriber module.

61. A smart card capable of being adapted to be associated with a local home electronic apparatus for broadcast reception, comprising a configuration block capable of being adapted to receive and store subscriber rights information from a remote electronic apparatus, and capable of being adapted to use said received information for allowing said local home electronic apparatus to enjoy broadcasted communication services autonomously with respect to said remote electronic apparatus.

62. The smart card according to claim 61, wherein said configuration block is capable of being adapted to receive and store subscriber rights information from a smart card associated with said remote electronic apparatus.

63. The smart card according to claim 61, comprising a radio communication unit for wireless communication.

64. The smart card according to claim 61, comprising subscriber rights verification and video streaming keys generation functionalities of a television smart card.
